(19) United States
(12) Patent Application Publication
(10) Pub. No.: US 2016/0042337 A1
(43) Pub. Date: Feb. 11, 2016

(54) CRADLE, CRADLE CONTROL METHOD, AND CONTROL SYSTEM

(71) Applicant: Seiko Epson Corporation, Tokyo (JP)

(72) Inventors: Toshihiro Ota, Fujimi-machi (JP); Yoshiki Kinoshita, Suwa-shi (JP); Shinichi Yoshie, Tatsuno-machi (JP); Hideki Nishimura, Matsmoto-shi (JP)

(73) Assignee: Seiko Epson Corporation, Tokyo (JP)

(21) Appl. No.: 14/808,687

(22) Filed: Jul. 24, 2015

(30) Foreign Application Priority Data
Aug. 11, 2014 (JP) 2014-163533
Aug. 28, 2014 (JP) 2014-173888

(51) Int. Cl. G06Q 20/20; G06Q 50/12; G07G 1/14; G07G 5/00; G07G 1/00

(52) U.S. Cl. CPC G06Q 20/202; G07G 5/00; G07G 1/0027; G07G 1/14; G06Q 20/209; G06Q 50/12

(57) ABSTRACT

A cradle in which a recording device can be installed charges the installed recording device and can execute processes using the ability for a recording device to be installed. A cradle 13 accepts a mobile printer 11, can charge a mobile printer 11 installed to the cradle 13, and has a control unit 40 that communicates with the installed mobile printer 11 and runs a specific process.

### BACKGROUND

1. Technical Field

The present invention relates to a cradle, a cradle control method, and a control system.

2. Related Art

JP-A-2009-17067 describes technology enabling a system combining a mobile terminal and a cradle to send control signals to a controlled device by infrared communication. In this system, the cradle holds a mobile terminal, receives program reservation information sent from the cradled mobile terminal, and generates a control signal for sending the program reservation information to a television, recorder, or other controlled device.

Mobile recording devices are now quite common. Such recording devices are typically placed in a cradle for charging as described in JP-A-2009-17067. There is thus a need for a cradle that can charge a recording device installed thereto and enables executing processes based on the ability of a recording device to be installed to the cradle.

### SUMMARY

The present invention is directed to this problem, and provides a cradle that charges a recording device installed to the cradle and enables executing processes based on the ability for a recording device to be installed to the cradle.

A first aspect of the invention is a cradle that charges an installed recording device, and has a control unit that communicates with the installed recording device and executes a specific process.

Thus comprised, the cradle can execute a process using the ability of a recording device to be installed to the cradle.

The cradle preferably also has a first communication unit that communicates with an external device, and a second communication unit that communicates with the recording device. The control unit configures the recording device through the second communication unit based on communication with the external device through the first communication unit.

This aspect of the invention simplifies the task of configuring the recording device.

Further preferably, the control unit updates firmware of the recording device through the second communication unit based on communication with the external device through the first communication unit.

Thus comprised, the firmware update process being interrupted due to the rechargeable battery of the recording device becoming drained can be prevented.

Further preferably, the control unit detects if the recording device is installed, and if installation of the recording device is detected, acquires a status related to configuration of the recording device through the second communication unit, and executes a process appropriate to the status related to configuration of the recording device acquired through the second communication unit.

This aspect of the invention reduces the involvement of the user in configuring the recording device.

In a cradle according to another aspect of the invention, the cradle is connected by wire to a cash drawer; and the control unit communicates with the installed recording device, and outputs a signal to open the cash drawer based on control of the installed recording device.

This aspect of the invention enables securely controlling the cash drawer without connecting the recording device and the cash drawer by wire.

In a cradle according to another aspect of the invention, the control unit authenticates the installed recording device when a recording device is installed, and if authentication is successful, outputs a signal to the cash drawer based on control of the recording device.

This aspect of the invention prevents an unauthorized recording device from opening the cash drawer.

Another aspect of the invention is a control method of a cradle that charges an installed recording device, including: communicating with the installed recording device and executing a specific process.

Thus comprised, the cradle can execute a process using the ability of a recording device to be installed to the cradle.

The control method of a cradle according to another aspect of the invention further includes: communicating with an external device; and configuring the recording device based on communication with the external device.

This aspect of the invention simplifies the task of configuring the recording device.

The control method of a cradle according to another aspect of the invention further includes: communicating with an installed recording device; and outputting a signal to a cash drawer connected by wire to open the cash drawer based on control of the installed recording device.

This aspect of the invention enables securely controlling the cash drawer without connecting the recording device and the cash drawer by wire.

Another aspect of the invention is a control system including: a cradle that charges an installed recording device; and a cash drawer connected by wire to the cradle; wherein the cradle communicates with the installed recording device, and outputs a signal to open the cash drawer based on control of the installed recording device.

This aspect of the invention enables securely controlling the cash drawer without connecting the recording device and the cash drawer by wire.

A control system according to another aspect of the invention includes a control device that communicates with the recording device. The recording device controls the cradle and outputs a signal to the cash drawer based on control of the control device.

This aspect of the invention enables the control device to control opening the cash drawer securely.

In a control system according to another aspect of the invention, the control device sends control data instructing recording on a recording medium to the recording device; and the recording device records on the recording medium based on the received control data.

This aspect of the invention enables securely opening the cash drawer in a system that produces receipts for transactions.

Further preferably in a control system according to another aspect of the invention, the cradle authenticates the installed recording device when a recording device is installed, and if authentication is successful, outputs a signal to the cash drawer based on control of the recording device.

This aspect of the invention prevents an unauthorized recording device from opening the cash drawer.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 illustrates an example of how a control system according to a first embodiment of the invention may be used.

FIG. 2 is a network diagram of the control system.

FIG. 3 is a side view of the cradle.

FIG. 4 is a block diagram illustrating the functional configuration of the control system.

FIG. 5 is a flow chart illustrating the operation of devices in the control system.

FIG. 6 is a flow chart illustrating the operation of devices in the control system.

FIG. 7 shows an example of a user interface for system configuration.

FIG. 8 illustrates an example of how a control system according to a second embodiment of the invention may be used.

FIG. 9 is a side view of a cradle and cash drawer.

FIG. 10 is a block diagram illustrating the functional configuration of the control system.

FIG. 11 is a flow chart illustrating the operation of devices in the control system.

### DESCRIPTION OF EMBODIMENTS

### Embodiment 1

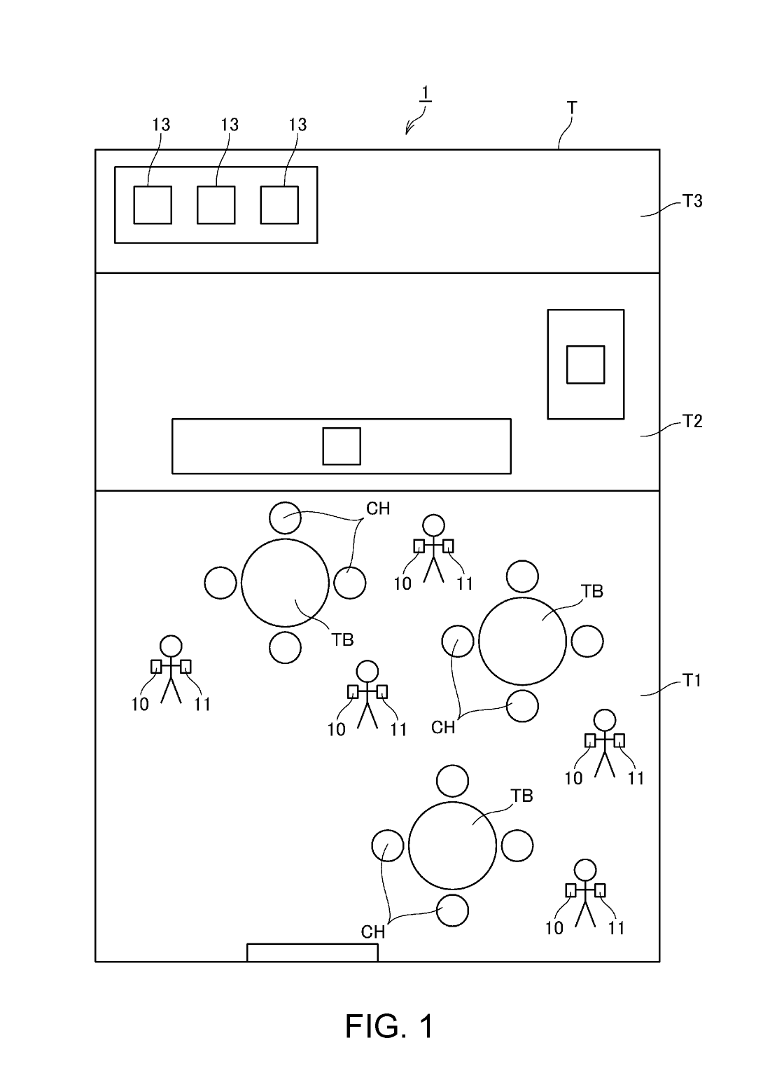

FIG. 1 illustrates how a control system 1 according to the first embodiment of the invention may be used.

FIG. 1 shows an example of a control system 1 according to the invention deployed in a restaurant T that serves food and drinks to customers.

The restaurant T shown in FIG. 1 is divided into a dining room T1, a kitchen T2, and an employee workroom T3.

The dining room T1 is where customers of the restaurant T sit and where the wait staff (referred to below as waiters) in the dining room T1 serve food and drinks to the customers. Multiple waiters work in the dining room T1. Multiple tables TB where food and drinks can be placed are arranged in the dining room T1, and multiple chairs CH are placed at each table TB.

A tablet terminal 10 (control device) used to take customer orders is previously assigned to each of the plural waiters. A tablet terminal 10 is a tablet computer with a touch panel 21 on the front.

A mobile printer 11 (recording device, printing device) is also previously assigned to each of the plural waiters. The mobile printer 11 is a portable, compact thermal printer, and is carried in a dedicated case worn on the waiter's belt, for example. The mobile printer 11 holds a paper roll (recording medium, print medium), records images on the roll paper with a thermal head, cuts the roll paper at a specific position, and produces a ticket on which images are recorded. The tablet terminal 10 and mobile printer 11 communicate wirelessly by a specific wireless communication protocol.

The waiters also carry a storage case for storing money.

When taking an order from a customer in the restaurant T, the waiter processes payment for the order on the spot.

More specifically, when an order is received from a customer in the restaurant T, a waiter goes to the customer, takes the order, and inputs the order to the tablet terminal 10. Based on the order input to the tablet terminal 10, the tablet terminal 10 executes a transaction process and calculates the total amount due. In response to the transaction process of the tablet terminal 10, the waiter receives payment from the customer and makes change appropriately, completing the transaction.

The mobile printer 11 then prints a receipt recording information related to the transaction as controlled by the tablet terminal 10. The mobile printer 11 also produces an order ticket recording at least the names of the ordered items and the quantity ordered as controlled by the tablet terminal 10. The waiter gives the receipt printed by the mobile printer 11 to the customer. The waiter also places the order ticket produced by the mobile printer 11 at a specific position in the kitchen T2.

The kitchen T2 is where the kitchen T2 staff (referred to below as kitchen staff) prepare the food and drinks, and is where drink machines, stoves, refrigerators and other equipment are installed. The kitchen staff get order tickets from the specific location where they are placed by the waiters, and prepare the food and drinks that were ordered based on the order ticket. The waiter then takes the items prepared by the kitchen staff and delivers the ordered items to the customer.

Multiple cradles 13 are located in the employee workroom T3. A mobile printer 11 can be placed in the cradle 13, and the cradle 13 charges the cradled mobile printer 11. The waiter places the mobile printer 11 in the cradle 13 to charge the mobile printer 11 as needed.

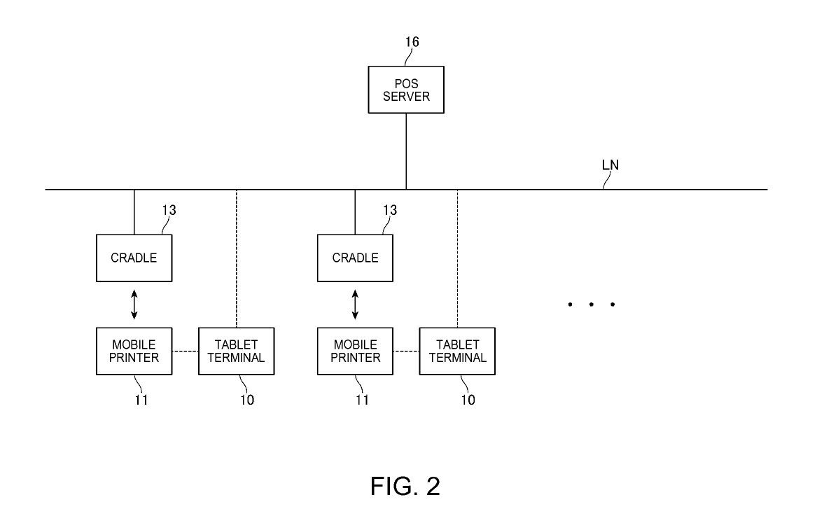

FIG. 2 is a network diagram of the control system 1.

As shown in FIG. 2, the control system 1 includes mobile printers 11 and tablet terminals 10, which are connected to communicate wirelessly.

A mobile printer 11 can be plugged into a cradle 13. The cradle 13 then charges the cradled mobile printer 11. As described further below, each cradle 13 is communicatively connected with the mobile printer 11 held in the cradle 13.

A network LN including a LAN is deployed in the restaurant T. The cradle 13 is connected by wire to the network LN. Communication by the cradle 13 through the network LN is described further below.

The tablet terminal 10 is wirelessly connected to the network LN. A POS server 16 is connected by wire to the network LN. The POS server 16 stores a product database DB1 and other databases of information required for the tablet terminal 10 to run the transaction process. When executing the transaction process, the tablet terminal 10 accesses the POS server 16 through the network LN and acquires the required information from the POS server 16.

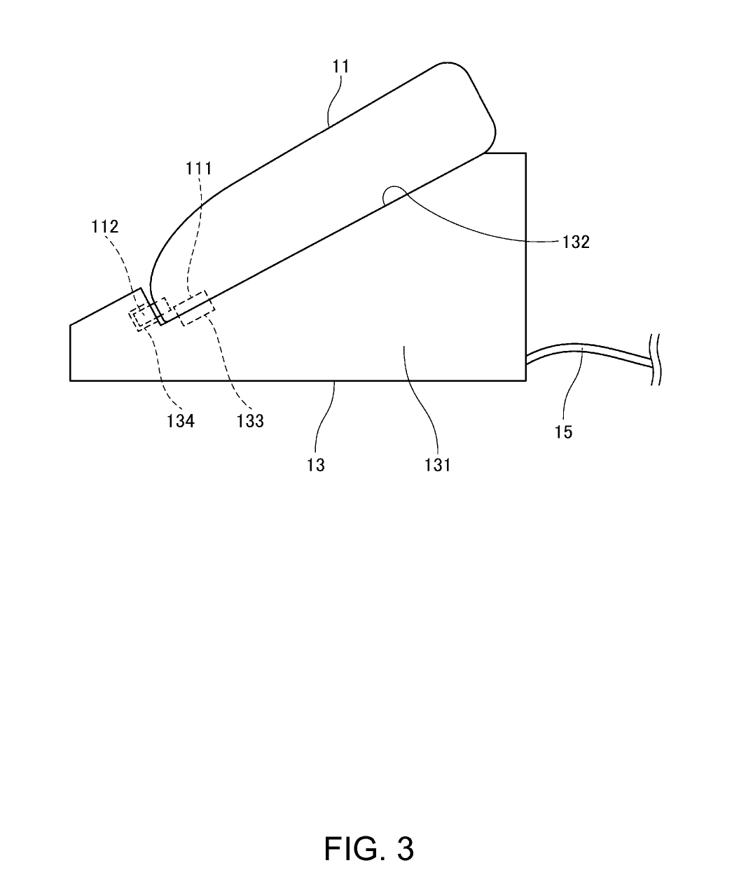

FIG. 3 is a side view suitable for describing a cradle 13 disposed in the employee workroom T3. The mobile printer 11 is already installed to the cradle 13 in FIG. 3.

As shown in FIG. 3, the cradle 13 has a case 131. A sloped holder 132 on which the mobile printer 11 can be placed is formed on the top of the case 131. When a mobile printer 11 is placed on the holder 132 of the cradle 13, the mobile printer 11 is locked in place by a lock mechanism not shown. The lock mechanism is unlocked by a release mechanism not shown. The mobile printer 11 is installed in the cradle 13 when the mobile printer 11 is placed on the holder 132 and the lock mechanism is engaged.

A charging terminal 111 is disposed to the bottom of the mobile printer 11. An electrode terminal 133 is disposed to the holder 132 of the cradle 13 at a position opposite the charging terminal 111 when the mobile printer 11 is installed. When the mobile printer 11 is installed in the cradle 13, the charging terminal 111 of the mobile printer 11 contacts the electrode terminal 133 of the cradle 13. Power is supplied from the cradle 13 through the electrode terminal 133 and charging terminal 111 to the mobile printer 11, and the mobile printer 11 is thereby charged.

A USB terminal 112 conforming to the USB standard is disposed to the distal end of the mobile printer 11. A USB connector 134 conforming to the USB standard is disposed to the case 131 of the cradle 13 at a position corresponding to the USB terminal 112 of the mobile printer 11 when the mobile printer 11 is installed. When the mobile printer 11 is installed in the cradle 13, the USB terminal 112 of the mobile printer 11 mates with the USB connector 134 of the cradle 13, and these parts are electrically connected.

A LAN cable 15 also connects to the cradle 13. The LAN cable 15 is connected to a router (not shown in the figure) connected to the network LN. The cradle 13 communicates with devices on the network LN through the LAN cable 15.

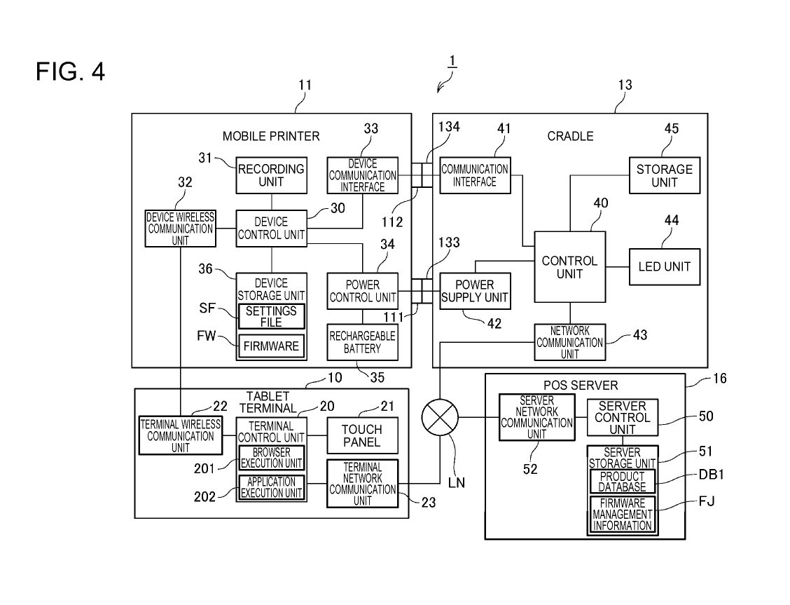

FIG. 4 is a block diagram illustrating the functional configuration of the control system 1.

As shown in FIG. 4, the tablet terminal 10 has a terminal control unit 20, a touch panel 21, a terminal wireless communication unit 22, and a terminal network communication unit 23.

The terminal control unit 20 includes a CPU, ROM, RAM, and other peripheral circuits and controls the tablet terminal 10.

A web browser is installed to the tablet terminal 10. The terminal control unit 20 functions as a browser execution unit 201 by reading and running the web browser.

A POS application is also installed on the tablet terminal 10. The terminal control unit 20 functions as an application execution unit 202 by reading and running the POS application.

The touch panel 21 includes an LCD panel or other type of display panel, and a touch sensor disposed over the display panel. The touch panel 21 displays images on the display panel as controlled by the terminal control unit 20. The touch panel 21 also detects and outputs touch operations by the user (the waiter in this example) to the terminal control unit 20. Based on input from the touch panel 21, the terminal control unit 20 runs processes appropriate to the touch operation.

The terminal wireless communication unit 22 communicates wirelessly with the mobile printer 11 according to a specific wireless communication protocol. Any suitable wireless communication standard may be used, such as a standard related to the infrastructure mode of a wireless LAN for communicating through an access point, a standard related to the ad hoc mode of a wireless LAN for communicating without going through an access point, or a near-field communication standard such as Bluetooth™.

The terminal network communication unit 23 communicates with devices connected to the network LN according to a specific communication protocol as controlled by the terminal control unit 20.

As shown in FIG. 4, the mobile printer 11 has a device control unit 30, a recording unit 31, a device wireless communication unit 32, a device communication interface 33, a power control unit 34, a rechargeable battery 35, and a device storage unit 36.

The device control unit 30 includes CPU, ROM, RAM, and other peripheral circuits and controls the mobile printer 11. The device control unit 30 controls the mobile printer 11 by reading and running firmware FW stored in the device storage unit 36 described below.

The recording unit 31 includes a thermal head for forming dots on thermal roll paper, a conveyance mechanism for conveying the roll paper, and a cutter unit for cutting the roll paper. The recording unit 31 forms dots on the roll paper and records images while conveying the roll paper as controlled by the device control unit 30. The recording unit 31 also cuts the roll paper at a specific position as controlled by the device control unit 30 and issues a ticket with images recorded thereon.

The device wireless communication unit 32 communicates wirelessly with the tablet terminal 10 as controlled by the device control unit 30 according to a specific wireless communication protocol.

The device communication interface 33 communicates by USB with the cradle 13 as controlled by the device control unit 30.

The power control unit 34 controls the power supplied to the other parts of the mobile printer 11 from the rechargeable battery 35 used as the power source as controlled by the device control unit 30. While a mobile printer 11 is installed in the cradle 13, the power control unit 34 also supplies power supplied from the cradle 13 to the rechargeable battery 35, and charges the rechargeable battery 35.

The device storage unit 36 includes EEPROM or other nonvolatile memory and stores data. Firmware FW is stored in the device storage unit 36. A settings file SF is also stored in the device storage unit 36.

As shown in FIG. 4, the cradle 13 has a control unit 40, a communication interface 41 (second communication unit), a power supply unit 42, a network communication unit 43 (first communication unit), an LED unit 44, and a storage unit 45.

The control unit 40 includes CPU, ROM, RAM, and other peripheral circuits and controls the cradle 13.

The communication interface 41 communicates by USB with the mobile printer 11 as controlled by the control unit 40.

The power supply unit 42 receives power from a commercial power supply and supplies power to the mobile printer 11 while the mobile printer 11 is connected to the cradle 13.

The network communication unit 43 communicates with devices connected to the network LN by a specific communication protocol as controlled by the control unit 40.

The LED unit 44 has plural LEDs. The LED unit 44 turns the plural LEDs on/off in specific ways to indicate the status of the cradle 13 and whether or not an error has occurred as controlled by the control unit 40.

The storage unit 45 includes EEPROM or other nonvolatile memory and stores data.

As shown in FIG. 4, the POS server 16 has a server control unit 50, a server storage unit 51, and a server network communication unit 52.

The server control unit 50 includes a CPU, ROM, RAM, and other peripheral circuits not shown, and controls the POS server 16.

The server storage unit 51 includes a nonvolatile storage device such as a hard disk drive or EEPROM, and stores data. The server storage unit 51 stores the product database DB1 described above. Other data stored by the server storage unit 51 is also described below.

The server network communication unit 52 communicates with devices connected to the network LN according to a specific communication protocol as controlled by the server control unit 50.

The operation of the tablet terminal 10, mobile printer 11, and POS server 16 are described next.

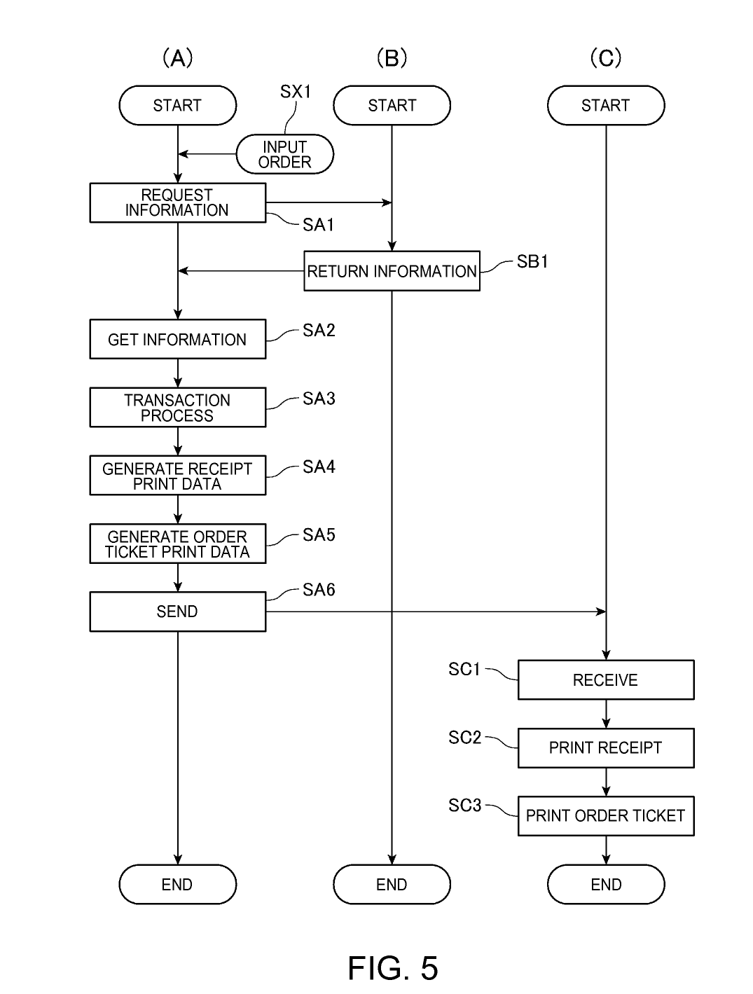

FIG. 5 is a flow chart of the operation the tablet terminal 10, mobile printer 11, and POS server 16 during a transaction. Column (A) of FIG. 5 shows the operation of the tablet terminal 10, (B) shows the operation of the POS server 16, and (C) shows the operation of the mobile printer 11.

The POS application of the tablet terminal 10 is started before the operation shown in column (A) of FIG. 5 starts. In addition to functions for running the process described below, the POS application has functions for providing a user interface for inputting customer orders.

As shown in column (A) of FIG. 5, when taking a customer order, the waiter inputs the order through a user interface displayed by a function of the POS application (step SX1).

The application execution unit 202 of the terminal control unit 20 of the tablet terminal 10 then queries the POS server 16 for the information needed to process the transaction based on the input order content, including the name and price of each ordered product (step SA1). The application execution unit 202 queries the POS server 16 in step SA1 by controlling the terminal network communication unit 23 to send specific commands to the POS server 16.

As shown in column (B) of FIG. 5, the server control unit 50 of the POS server 16 responds to the query from the application execution unit 202 based on information retrieved from the product database DB1 (step SB1).

As shown in column (A) of FIG. 5, the application execution unit 202 of the terminal control unit 20 of the terminal control unit 20 acquires the information required to process the transaction based on the response to the query (step SA2).

Next, the application execution unit 202 processes the transaction based on information from input to the user interface, the information acquired in step SA2, and other information (step SA3).

In step SA3, the application execution unit 202 calculates the total purchase amount, for example. As described above, payment from the customer is then received according to the transaction process and the waiters make change as needed, completing the transaction.

Next, the application execution unit 202 generates control data (“receipt print data” below) for producing a receipt recording information related to the transaction (step SA4). The control data is generated using commands conforming to the command language of the mobile printer 11.

Next, the application execution unit 202 generates control data (“order ticket print data” below) for printing an order ticket (step SA5).

Next, the application execution unit 202 controls the terminal wireless communication unit 22 to send the receipt print data generated in step SA4 and the order ticket print data generated in step SA5 to the mobile printer 11 (step SA6).

As shown in column (C) of FIG. 5, the device control unit 30 of the mobile printer 11 controls the device wireless communication unit 32 to receive the receipt print data and order ticket print data (step SC1).

Next, the device control unit 30 controls the recording unit 31 based on the received receipt print data to produce a receipt (step SC2). As described above, the printed receipt is then given to the customer.

Next, the device control unit 30 controls the recording unit 31 based on the received order ticket print data to print an order ticket (step SC3). As described above, the printed order ticket is delivered to the kitchen staff.

As described above, a settings file SF is stored in the device storage unit 36 of the mobile printer 11. The settings file SF contains multiple sets of parameters to set and the values to set for those parameters (referred to below as simply “settings”). Plural settings are thus stored in the settings file SF. Setting a setting below means storing a value for a particular parameter.

The parameters include, for example, the recording speed (print speed). The values that can be set for the recording speed in this example are HIGH, indicating the highest speed, MEDIUM indicating a slower speed, and LOW indicating the lowest speed.

Another parameter is the recording density (print density). The values that can be set for the recording density parameter in this example are HIGH denoting the darkest setting, and LOW denoting the lightest setting.

When controlling the recording unit 31, the mobile printer 11 references the settings file SF and controls the recording unit 31 according to the settings recorded in the settings file SF.

As described above, firmware FW is also stored in the device storage unit 36 of the mobile printer 11. The terminal control unit 20 controls the control system 1 by reading and running the firmware FW. Because the firmware FW is updated occasionally, the firmware FW must be updated appropriately after an update becomes available.

Settings are conventionally made in a compact, portable printer such as the mobile printer 11 according to this embodiment as described below. First, the user connects a dedicated terminal on which a dedicated software tool is installed to the mobile printer 11. Next, the user inputs the information required for the settings through a user interface provided by a function of the dedicated software tool. The dedicated terminal then communicates with the mobile printer 11 and controls the mobile printer 11 to overwrite settings recorded in the settings file SF based on the information input to the user interface.

Firmware FW is similarly updated as described below. First, the user downloads to the dedicated terminal a program file of the firmware FW to update. Next, the user inputs a command to update the firmware FW to a user interface provided by a function of the dedicated software tool. The dedicated terminal then communicates with the mobile printer 11 and controls the mobile printer 11 to update the firmware FW based on the downloaded program file.

Note that setting settings and updating firmware FW are examples of setting (configuring) the mobile printer 11 (recording device).

Changing settings and updating firmware FW by the foregoing method is complicated, requiring the user to use a dedicated terminal and connect the dedicated terminal to the mobile printer 11. Because a dedicated terminal is required, there is also room for improvement in terms of cost.

As a result, configuring the mobile printer 11 (inputting settings and updating the firmware FW, for example) in this embodiment is done by devices in the control system 1 executing the following process.

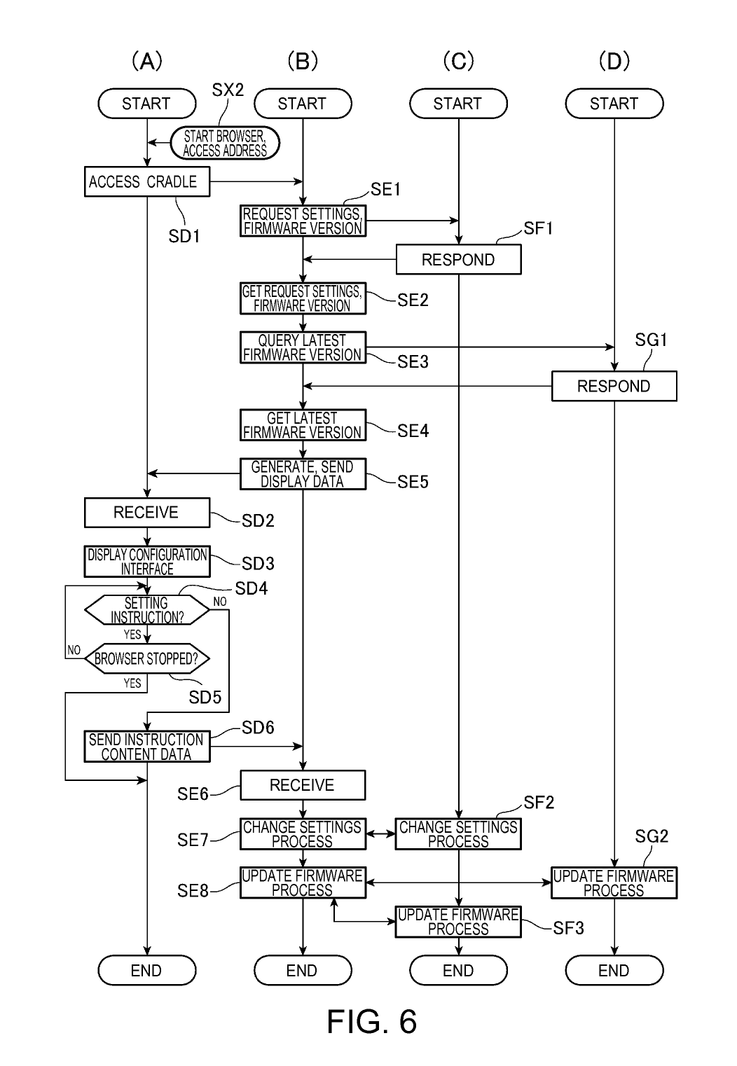

FIG. 6 is a flowchart of the operation of devices in the control system 1 when configuring the mobile printer 11. Column (A) of FIG. 6 shows the operation of the tablet terminal 10, (B) shows the operation of the cradle 13, (C) shows the operation of the mobile printer 11, and (D) shows the operation of the POS server 16.

In this embodiment, web server software (such as Apache HTTP Server) is installed on the cradle 13. The cradle 13 can function as a web server that generates and outputs display data according to a specific communication protocol such as HTTP in response to a request from a client.

The settings set in the process described with reference to FIG. 6 are the value of the recording speed parameter, and the value of the recording density parameter.

To configure the mobile printer 11, the user first places the mobile printer 11 in the cradle 13. When the process shown in FIG. 6 starts, the mobile printer 11 is already loaded in the cradle 13 and can communicate with the cradle 13.

As shown in column (A) of FIG. 6, to configure the mobile printer 11, the user first starts the web browser on the tablet terminal 10. Next, the user inputs the specific address of the cradle 13 (a URL or IP address) and a command to access the input address (step SX2). Note that the address of the cradle 13 is previously given to the user by a desirable method.

When accessing the specific address of the cradle 13 is commanded, the browser execution unit 201 of the terminal control unit 20 of the tablet terminal 10 accesses the input address (step SD1). When accessing this address, the browser execution unit 201 handshakes with the cradle 13 according to a specific communication protocol, and establishes a connection with the cradle 13.

As shown in column (B) of FIG. 6, when the specific address is accessed from the tablet terminal 10, the control unit 40 of the cradle 13 requests the mobile printer 11 to return its settings and the version of firmware FW installed (step SE1). This is done in step SE1 by the control unit 40 then controlling the communication interface 41 to send a specific command to the mobile printer 11.

As shown in column (C) of FIG. 6, the device control unit 30 of the mobile printer 11 returns the settings and the firmware FW version in response to the request from the cradle 13 (step SF1). More specifically, the device control unit 30 references the settings file SF stored by the device storage unit 36. The version of the firmware FW is stored in addition to the settings in the settings file SF. Next, the device control unit 30 acquires the settings and firmware FW version based on the information recorded in the settings file SF. Next, the device control unit 30 controls the device communication interface 33 to send the acquired settings and firmware FW version to the cradle 13.

As shown in column (B) of FIG. 6, the control unit 40 of the cradle 13 acquires the settings and firmware FW version of the mobile printer 11 based on the response from the mobile printer 11 (step SE2).

Next, the control unit 40 queries the POS server 16 for the latest version of the firmware FW that can be installed on the mobile printer 11 (step SE3). This is done by the control unit 40 controlling the network communication unit 43 to send a specific command to the POS server 16.

The server storage unit 51 of the POS server 16 stores firmware management information FJ relating each version of firmware FW to the program file of the firmware FW for each firmware FW that can be installed on the mobile printer 11. The firmware management information FJ is updated appropriately by a specific method.

As shown in column (D) of FIG. 6, in response to the query of step SE3, the server control unit 50 of the POS server 16 references the firmware management information FJ and returns the latest version of firmware FW that can be installed to the mobile printer 11 (step SG1).

As shown in column (B) of FIG. 6, the control unit 40 of the cradle 13 acquires the latest version of firmware FW that can be installed to the mobile printer 11 based on the response from the POS server 16 (step SE4).

Next, the control unit 40 generates display to display a user interface for device configuration (“configuration interface” below) based on the information acquired in step SE2 and the information acquired in step SE4, and controls the network communication unit 43 to send the generated display data (step SE5). The display data is an HTML file, for example.

As shown in column (A) of FIG. 6, the browser execution unit 201 of the terminal control unit 20 of the tablet terminal 10 controls the terminal network communication unit 23 to receive the display data (step SD2).

Next, the browser execution unit 201 displays the configuration interface on the touch panel 21 based on the received display data (step SD3).

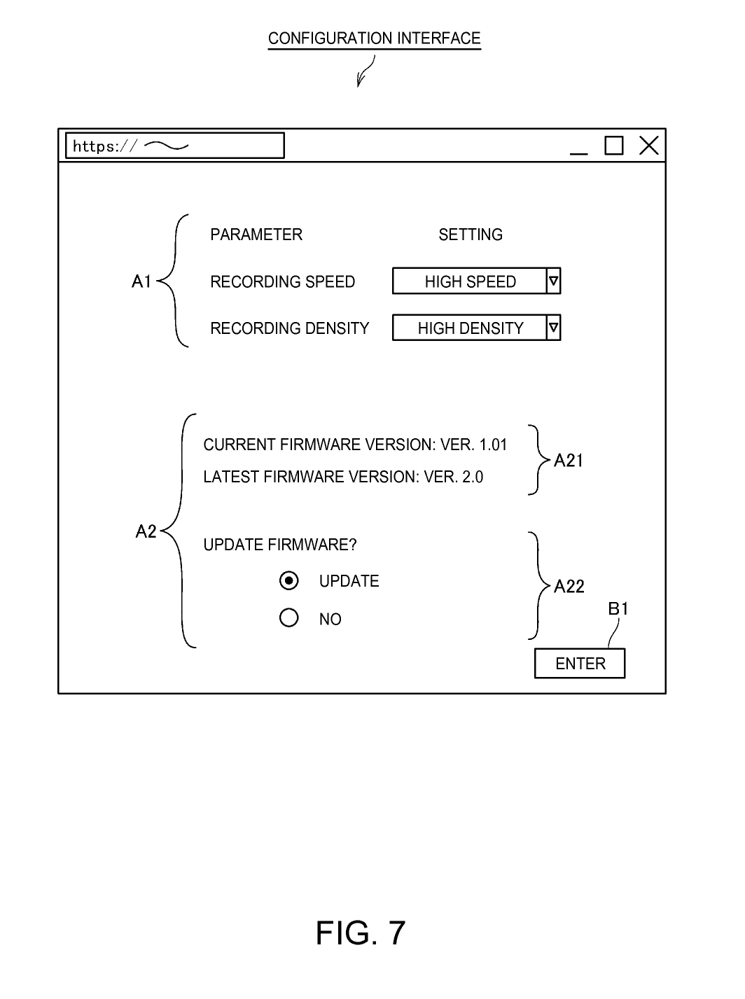

FIG. 7 shows an example of the configuration interface.

As shown in FIG. 7, the configuration interface has a settings area A1 and a version information area A2.

The settings area A1 is where information related to settings is displayed. More specifically, a list of parameters (recording speed and recording density in this example) and the values set for each parameter are displayed in the settings area A1. The default values of the displayed parameters (settings) are the values set in the mobile printer 11. The settings can be entered through pull-down menus, and the menus list the values that can be set for a particular parameter. The user simply selects the desired value from the pull-down menu to change the setting for the corresponding parameter.

The version information area A2 is where information related to the firmware FW version is displayed. More specifically, the version information area A2 has a first display area A21 and a second display area A22.

The version of firmware FW installed on the mobile printer 11, and the most recent version of firmware FW that can be installed on the mobile printer 11, are displayed in the first display area A21.

The second display area A22 is presented when the newest version of the firmware FW that can be installed on the mobile printer 11 is newer than the firmware FW version currently installed on the mobile printer 11. Radio buttons for selecting whether or not to update to the newest version of firmware FW are provided in the second display area A22 as shown in FIG. 7.

To change the value of one setting, the user taps on the pull-down menu corresponding to the parameter to set in settings area A1, and selects a value other than the value that is currently set. Next, the user taps button B1 to confirm the input.

To update to the latest firmware FW version, the user selects the appropriate radio button in second display area A22. Next, the user taps button B1 to confirm the input.

Note that the control unit 40 of the cradle 13 generates the display data for displaying the configuration interface shown in FIG. 7 in step SE5 in column (B) of FIG. 6.

After the configuration interface is displayed, the browser execution unit 201 checks if one of the settings was changed or if a command to update the firmware FW was asserted in the configuration interface (step SD4). While step SD4 is running, the browser execution unit 201 checks if the web browser is closed by the user (step SD5). If the web browser is closed (step SD5: YES), the browser execution unit 201 stops the process.

If a setting is changed or updating the firmware FW is selected in the configuration interface (step SD4: YES), the browser execution unit 201 goes to step SD6. In step SD6, the browser execution unit 201 generates and sends data containing the content of the selections made in the configuration interface (“instruction content data” below) to the cradle 13 by the terminal network communication unit 23.

As shown in column (B) of FIG. 6, the control unit 40 of the cradle 13 controls the network communication unit 43 to receive the instruction content data sent by the tablet terminal 10 in step SD6 (step SE6).

Next, the control unit 40 of the cradle 13 and the device control unit 30 of the mobile printer 11 work together to run a change settings process (step SE7, step SF2).

The change settings process is a process for overwriting the information related to the corresponding setting recorded in the settings file SF for any parameter setting to be changed. If there is no command to change a setting, the change settings process is not executed.

In the change settings process, the control unit 40 of the cradle 13 gets the combination of parameter and setting (value) to be changed based on the received instruction content data. Next, the control unit 40 generates control data instructing changing the setting for which a new value was selected, and sends the control data to the mobile printer 11. The device control unit 30 of the mobile printer 11 then receives the control data, and based on the received control data rewrites the corresponding setting in the settings file SF.

Next, the control unit 40 of the cradle 13, the device control unit 30 of the mobile printer 11, and the server control unit 50 of the POS server 16 work together to execute the update firmware process (step SE8, step SG2, step SF3).

The update firmware process is a process for updating the firmware FW of the mobile printer 11. If updating the firmware FW is not selected (a command is not asserted), the update firmware process does not run.

In the update firmware process, the control unit 40 of the cradle 13 requests the server control unit 50 of the POS server 16 to send the program file for the latest version of the firmware FW. In response to this request, the server control unit 50 of the POS server 16 sends the program file for the latest version of the firmware FW (below, the “latest firmware”) to the control unit 40 of the cradle 13.

The control unit 40 of the cradle 13 then stores the received program file of the latest firmware in a specific storage area. Next, the control unit 40 of the cradle 13 controls the communication interface 41 to communicate with the device control unit 30 of the mobile printer 11 to send the program file stored for the latest firmware FW, and instructs updating the firmware FW based on the program file. In response to this command, the device control unit 30 of the mobile printer 11 updates the firmware FW based on the program file of the latest firmware version.

The firmware FW is the control program for the mobile printer 11. Therefore, failing to update the firmware FW successfully has a significant effect on the mobile printer 11. Interrupting the update process while the firmware FW is being updated is one cause of the update process not completing successfully. Because the mobile printer 11 operates on power supplied from a rechargeable battery 35, preventing the update process from being interrupted because the rechargeable battery 35 runs out of power during the process is necessary.

In this embodiment of the invention, the firmware FW of the mobile printer 11 is updated cooperatively by the mobile printer 11 and the cradle 13 while the mobile printer 11 is installed in the cradle 13 and power is supplied from the cradle 13 to the mobile printer 11. Updating the firmware FW being interrupted because the rechargeable battery 35 runs out of power can therefore be prevented, and the update process not completing successfully can be suppressed.

As described above, the cradle 13 according to this embodiment has a network communication unit 43 (first communication unit) that communicates with the tablet terminal 10 as an external device; a communication interface 41 (second communication unit) that communicates with a mobile printer 11 (recording device) installed in the cradle 13; and a control unit 40 that configures the mobile printer 11 through the communication interface 41 based on communication with the tablet terminal 10 through the network communication unit 43.

Thus comprised, a characteristic of the cradle 13 in which the mobile printer 11 is placed for charging, and the ability of the cradle 13 to communicate with the mobile printer 11 and an external device, are used to configure (set) operating parameters in the mobile printer 11. As a result, because the mobile printer 11 can be desirably configured without requiring a dedicated terminal to which dedicated software is installed, configuring the mobile printer 11 is easier. Cost can also be reduced by eliminating the need for a dedicated terminal.

The control unit 40 in this embodiment of the invention updates the firmware FW of the mobile printer 11 through the communication interface 41 based on communication with the tablet terminal 10 through the network communication unit 43.

Thus comprised, the updating processing stopping because the rechargeable battery 35 runs out of power while updating the firmware FW can be prevented.

### Variation of Embodiment 1

A variation of the first embodiment of the invention is described next.

The cradle 13 in the first embodiment described above configures the mobile printer 11 based on a command from the tablet terminal 10. In this variation of the first embodiment, the cradle 13 configures the mobile printer 11 automatically when a specific condition is met.

More specifically, the control unit 40 of the cradle 13 monitors whether or not a mobile printer 11 was installed through the USB connection. If installing the mobile printer 11 in the cradle 13 is detected, the control unit 40 communicates through the communication interface 41 with the device control unit 30 of the mobile printer 11, and gets the version of the firmware FW in the mobile printer 11. The control unit 40 also communicates through the network communication unit 43 with the server control unit 50 of the POS server 16, and gets the latest version of the firmware.

Next, based on the acquired versions, the control unit 40 determines whether or not updating the mobile printer 11 to the latest version of the firmware FW is necessary. If necessary, the control unit 40 updates the firmware of the mobile printer 11 to the latest version in cooperation with the device control unit 30 of the mobile printer 11 and the server control unit 50 of the POS server 16.

While updating the firmware FW of the mobile printer 11, the control unit 40 drives LEDs of the LED unit 44 in a specific way to show that the firmware FW is being updated. The user can know from the LEDs that the firmware FW is being updated, and knows to not remove the mobile printer 11 from the cradle 13 during the update process.

As described above, in this variation of the first embodiment, the control unit 40 of the cradle 13 can detect if a mobile printer 11 is cradled, and if a mobile printer 11 has been cradled, gets the version of firmware FW in the mobile printer 11 (a state related to the configuration) through the communication interface 41, and executes a process (updating the firmware FW) appropriate to the acquired version.

As a result, when updating the firmware FW is necessary, the firmware FW is updated automatically when triggered by the mobile printer 11 being placed in the cradle 13. Involvement of the user in updating the firmware FW can therefore be reduced.

The invention is described above with reference to a preferred embodiment thereof, but the invention is not limited thereto and can be modified and adapted in many ways without departing from the scope of the accompanying claims.

For example, the mobile printer 11 and cradle 13 communicate by USB in the foregoing embodiment. Any desirable standard can be used for communication between devices, however, including Bluetooth or other near-field communication technology, and other wired communication standards.

The mobile printer 11 in the foregoing embodiment uses a thermal recording method, but the printing method is not limited to thermal recording.

The function units described above can also be achieved as desired using hardware and software, and do not suggest a specific hardware configuration.

### Embodiment 2

A second embodiment of the invention is described next.

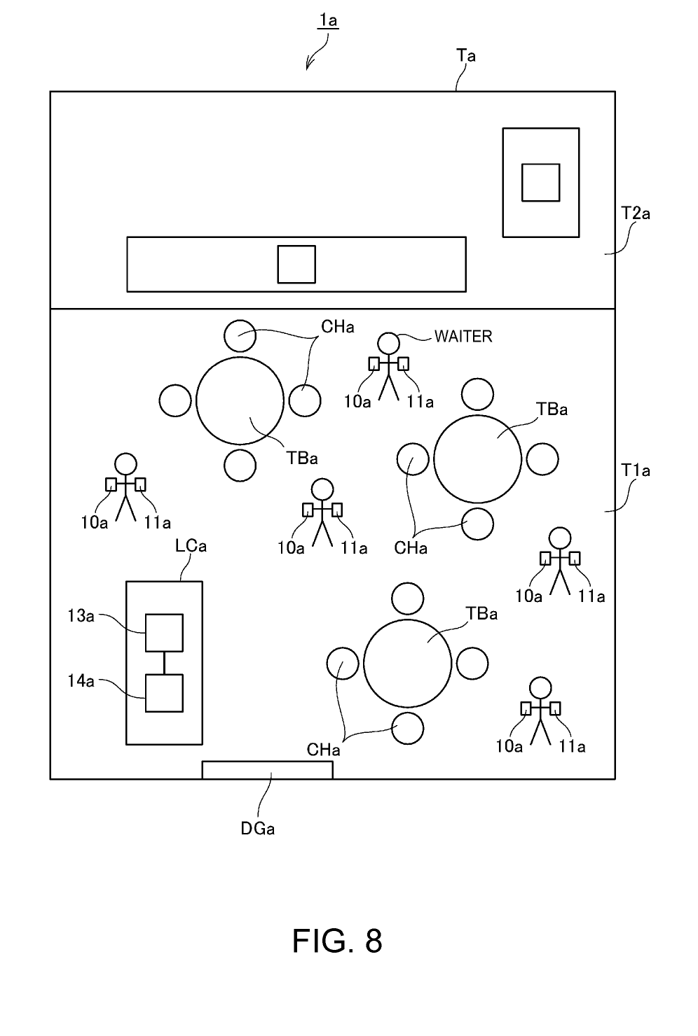

FIG. 8 illustrates how a control system 1a according to the second embodiment of the invention may be used.

FIG. 8 shows an example of a control system 1a according to the invention deployed in a restaurant T that serves food and drinks to customers.

The restaurant Ta shown in FIG. 8 is divided into a dining room T1a and a kitchen T2a.

The dining room T1a is where customers sit and where the wait staff (referred to below as waiters) in the dining room T1a serve food and drinks to the customers. Multiple waiters work in the dining room T1a. Multiple tables TBa where food and drinks can be placed are arranged in the dining room T1a, and multiple chairs CHa are placed at each table TBa.

A tablet terminal 10a (control device) used to take customer orders is previously assigned to each of the plural waiters. A tablet terminal 10a is a tablet computer with a touch panel 21a on the front.

A mobile printer 11a is also previously assigned to each of the plural waiters. The mobile printer 11a is a portable, compact thermal printer, and is carried in a dedicated case worn on the waiter's belt, for example. The mobile printer 11a holds a paper roll (recording medium), records images on the roll paper with a thermal head, cuts the roll paper at a specific position, and produces a ticket on which images are recorded. The tablet terminal 10a and mobile printer 11a communicate wirelessly by a specific wireless communication protocol.

When an order is received from a customer in the restaurant Ta, a waiter goes to the customer, takes the order, and inputs the order to the tablet terminal 10a. Based on the order input to the tablet terminal 10a, the mobile printer 11a then prints an order ticket recording at least the names of the ordered items and the quantity ordered as controlled by the tablet terminal 10a. The waiter gives the receipt printed by the mobile printer 11a to the customer. The waiter also places the order ticket produced by the mobile printer 11a at a specific position in the kitchen T2a.

The kitchen T2a is where the kitchen T2a staff (referred to below as kitchen staff) prepare the food and drinks, and is where drink machines, stoves, refrigerators and other equipment are installed. The kitchen staff get order tickets from the specific location where they are placed by the waiters, and prepare the food and drinks that were ordered based on the order ticket. The waiter then takes the items prepared by the kitchen staff and delivers the ordered items to the customer.

A checkout counter LCa where customers payment for their service is located near the exit DGa from the dining room T1a. A cradle 13a and a cash drawer 14a are installed at the checkout counter LCa. A mobile printer 11a can be plugged into the cradle 13a, and the cradle 13 can charge the cradled mobile printer 11a. Other functions of the cradle 13a are described below. The cradle 13a is connected by wire to the cash drawer 14a.

Customer transactions are completed at the checkout counter LCa. During the transaction, the waiter places his assigned mobile printer 11a in the cradle 13a. Next, the waiter inputs data appropriately to the transaction to the assigned tablet terminal 10a. Based on the transaction input by the waiter, the mobile printer 11a held in the cradle 13a produces a receipt printed with information related to the transaction as controlled by the tablet terminal 10a. The cash drawer 14a also opens in response to the transaction input by the waiter, enabling the waiter to take cash from the cash drawer 14a or place money in the cash drawer 14a. The waiter than gives the receipt to the customer and makes change appropriately.

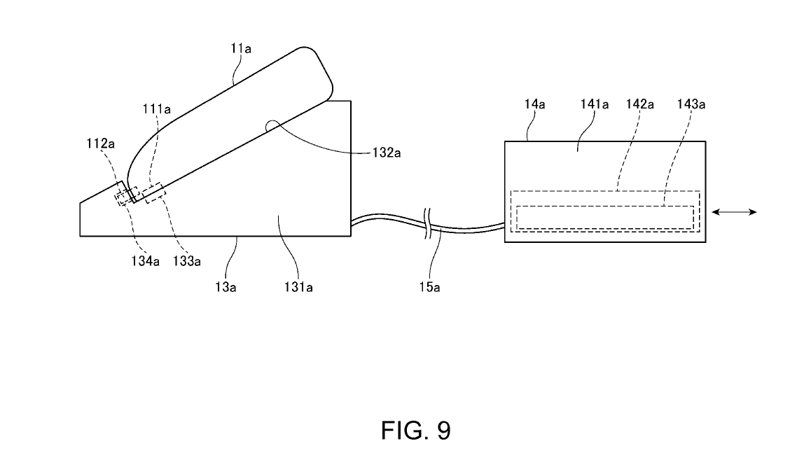

FIG. 9 is a side view of the cradle 13a disposed to the checkout counter LCa and a side view of the cash drawer 14a. The mobile printer 11a is already installed to the cradle 13a in FIG. 9.

As shown in FIG. 3, the cradle 13a has a case 131a. A sloped holder 132a on which the mobile printer 11a can be placed is formed on the top of the case 131a. When a mobile printer 11a is placed on the holder 132a of the cradle 13a, the mobile printer 11a is locked in place by a lock mechanism not shown. The lock mechanism is unlocked by a release mechanism not shown. The mobile printer 11a is installed in the cradle 13a when the mobile printer 11a is placed on the holder 132a and the lock mechanism is engaged.

A charging terminal 111a is disposed to the bottom of the mobile printer 11a. An electrode terminal 133a is disposed to the holder 132a of the cradle 13a at a position opposite the charging terminal 111a when the mobile printer 11a is installed. When the mobile printer 11a is installed in the cradle 13a, the charging terminal 111a of the mobile printer 11a contacts the electrode terminal 133a of the cradle 13a. Power is supplied from the cradle 13a through the electrode terminal 133a and charging terminal 111a to the mobile printer 11a, and the mobile printer 11a is thereby charged.

A USB terminal 112a conforming to the USB standard is disposed to the distal end of the mobile printer 11a. A USB connector 134a conforming to the USB standard is disposed to the case 131a of the cradle 13a at a position corresponding to the USB terminal 112a of the mobile printer 11a when the mobile printer 11a is installed. When the mobile printer 11a is installed in the cradle 13a, the USB terminal 112a of the mobile printer 11a mates with the USB connector 134a of the cradle 13a, and these parts are electrically connected.

As shown in FIG. 9, the cash drawer 14a is connected to the mobile printer 11a by a signal cable 15a.

The cash drawer 14a has a case 141a, and a drawer unit 142a that can move in and out of the case 141a. A cash tray 143a with pockets for holding different denominations of money is disposed in the drawer unit 142a.

When the drawer unit 142a is pulled out from the case 141a of the cash drawer 14a, the cash drawer 14a (drawer unit 142a) is open.

When the drawer unit 142a is closed (inside the case 141a), the drawer unit 142a is locked to the case 141a, preventing the drawer unit 142a from being pulled out manually from the case 141a.

The drawer unit 142a is pulled out from the case 141a by the method described below. When the drawer unit 142a is pulled out from the case 141a and open, the user (the waiter in this example) manually pushes the drawer unit 142a into the case 141a.

FIG. 4 is a block diagram illustrating the functional configuration of the control system 1a.

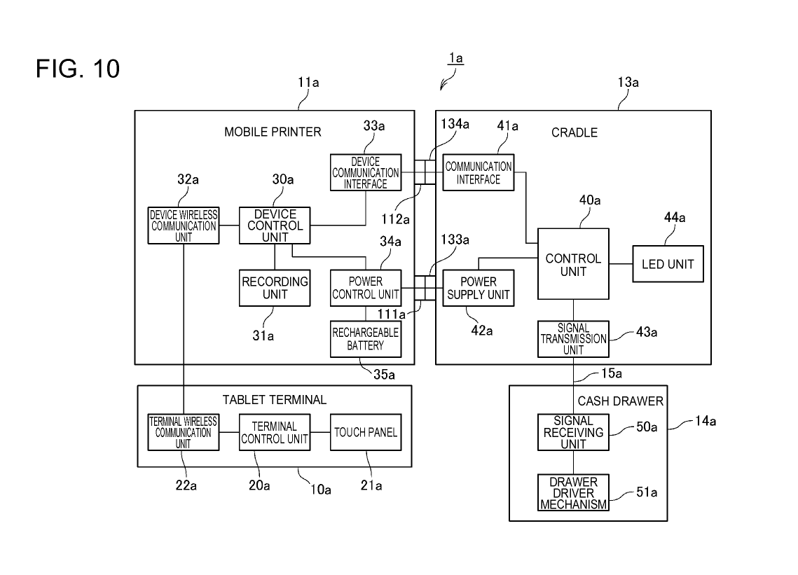

As shown in FIG. 10, the tablet terminal 10a has a terminal control unit 20a, a touch panel 21a, and a terminal wireless communication unit 22a.

The terminal control unit 20a includes a CPU, ROM, RAM, and other peripheral circuits and controls the tablet terminal 10a.

The touch panel 21a includes an LCD panel or other type of display panel, and a touch sensor disposed over the display panel. The touch panel 21a displays images on the display panel as controlled by the terminal control unit 20a. The touch panel 21a also detects and outputs touch operations by the user (the waiter in this example) to the terminal control unit 20a. Based on input from the touch panel 21a, the terminal control unit 20a runs processes appropriate to the touch operation.

The terminal wireless communication unit 22a communicates wirelessly with the mobile printer 11a according to a specific wireless communication protocol. Any suitable wireless communication standard may be used, such as a standard related to the infrastructure mode of a wireless LAN for communicating through an access point, a standard related to the ad hoc mode of a wireless LAN for communicating without going through an access point, or a near-field communication standard such as Bluetooth™.

As shown in FIG. 10, the mobile printer 11a has a device control unit 30a, a recording unit 31a, a device wireless communication unit 32a, a device communication interface 33a, a power control unit 34a, and a rechargeable battery 35a.

The device control unit 30a includes CPU, ROM, RAM, and other peripheral circuits and controls the mobile printer 11a.

The recording unit 31a includes a thermal head for forming dots on thermal roll paper, a conveyance mechanism for conveying the roll paper, and a cutter unit for cutting the roll paper. The recording unit 31a forms dots on the roll paper and records images while conveying the roll paper as controlled by the device control unit 30a. The recording unit 31a also cuts the roll paper at a specific position as controlled by the device control unit 30a and issues a ticket with images recorded thereon.

The device wireless communication unit 32a communicates wirelessly with the tablet terminal 10a as controlled by the device control unit 30a according to a specific wireless communication protocol.

The device communication interface 33a communicates by USB with the cradle 13a as controlled by the device control unit 30a.

The power control unit 34a controls the power supplied to the other parts of the mobile printer 11a from a rechargeable battery 35a used as the power source as controlled by the device control unit 30a. While a mobile printer 11a is installed in the cradle 13a, the power control unit 34a also supplies power supplied from the cradle 13a to the rechargeable battery 35a, and charges the rechargeable battery 35a.

As shown in FIG. 10, the cradle 13a has a control unit 40a, a communication interface 41a, a power supply unit 42a, a signal transmission unit 43a, and an LED unit 44a.

The control unit 40a includes CPU, ROM, RAM, and other peripheral circuits and controls the cradle 13a.

The communication interface 41a communicates by USB with the mobile printer 11a as controlled by the control unit 40a.

The power supply unit 42a receives power from a commercial power supply and supplies power to the mobile printer 11a while the mobile printer 11a is connected to the cradle 13a.

The network communication unit 43a sends specific signals (an “Open signal” below) telling the cash drawer 14a to open through the signal cable 15a to the cash drawer 14a as controlled by the control unit 40a.

The LED unit 44a has plural LEDs. The LED unit 44a turns the plural LEDs on/off in specific ways to indicate the status of the cradle 13a and whether or not an error has occurred as controlled by the control unit 40a.

As also shown in FIG. 10, the cash drawer 14a has a signal receiving unit 50a and a drawer driver mechanism 51a.

The signal receiving unit 50a receives the Open signal sent from the signal transmission unit 43a of the cradle 13a. When the Open signal is received, the signal receiving unit 50a generates a signal instructing opening the drawer, and outputs the signal to the drawer driver mechanism 51a.

The drawer driver mechanism 51a includes a lock mechanism for locking and unlocking the drawer unit 142a to the case 141a, a kicker mechanism that causes the drawer unit 142a to move in a specific direction and the drawer unit 142a to open, and a control circuit for controlling the lock mechanism and kicker mechanism.

When a signal instructing the drawer to open is input from the signal receiving unit 50a, the control circuit of the drawer driver mechanism 51a disengages the lock mechanism. Next, the control circuit of the drawer driver mechanism 51a controls the kicker mechanism to move the drawer unit 142a in the specific direction and the cash drawer 14a to open.

When the user manually pushes the drawer unit 142a back into the case 141a, the lock mechanism operates to lock the drawer unit 142a to the case 141a.

In the control system 1a shown in FIG. 8, each waiter has a mobile printer 11a. There are therefore plural mobile printers 11a in the dining room T1a. There is only one cash drawer 14a in the dining room T1a, however. The cash drawer 14a and mobile printers 11a are therefore in a one-to-many relationship, and multiple mobile printers 11a share one cash drawer 14a. Because money is stored in the cash drawer 14a, opening the cash drawer 14a must be securely controlled.

In a system in which multiple mobile printers 11a share a single cash drawer 14a as in the control system 1a shown by example in FIG. 8, the cash drawer 14a may be opened for a transaction as described below.

The cash drawer 14a is provided with a wireless communication capability. To open the cash drawer 14a, the mobile printer 11a sends a specific control signal by wireless communication to the cash drawer 14a, causing the cash drawer 14a to open. Security is therefore a problem because the cash drawer may potentially be accessed by hacking the wireless connection.

In a system in which one cash drawer 14a is shared by many mobile printers 11a, the cash drawer 14a may also be opened for a transaction by the following method. This method is to connect the mobile printer 11a to the cash drawer 14a by wire in order to open the cash drawer 14a. Unlike methods that communicate wirelessly with the cash drawer 14a, this method is secure but complicates operation for the waiter (user).

In a system in which one cash drawer 14a is shared by many mobile printers 11a, the cash drawer 14a may also be opened for a transaction by the following method. In this method, the mobile printer 11a and cash drawer 14a are always connected by wire. This method, however, sacrifices the mobility (portability) of the mobile printer 11a. This method can also not be used when the waiter wears the mobile printer 11a as in this embodiment of the invention.

By executing the processes described below, the devices in a control system 1a according to this embodiment as shown in FIG. 8 to FIG. 10 can securely open the cash drawer 14a for a transaction without connecting the mobile printer 11a and cash drawer 14a by wire.

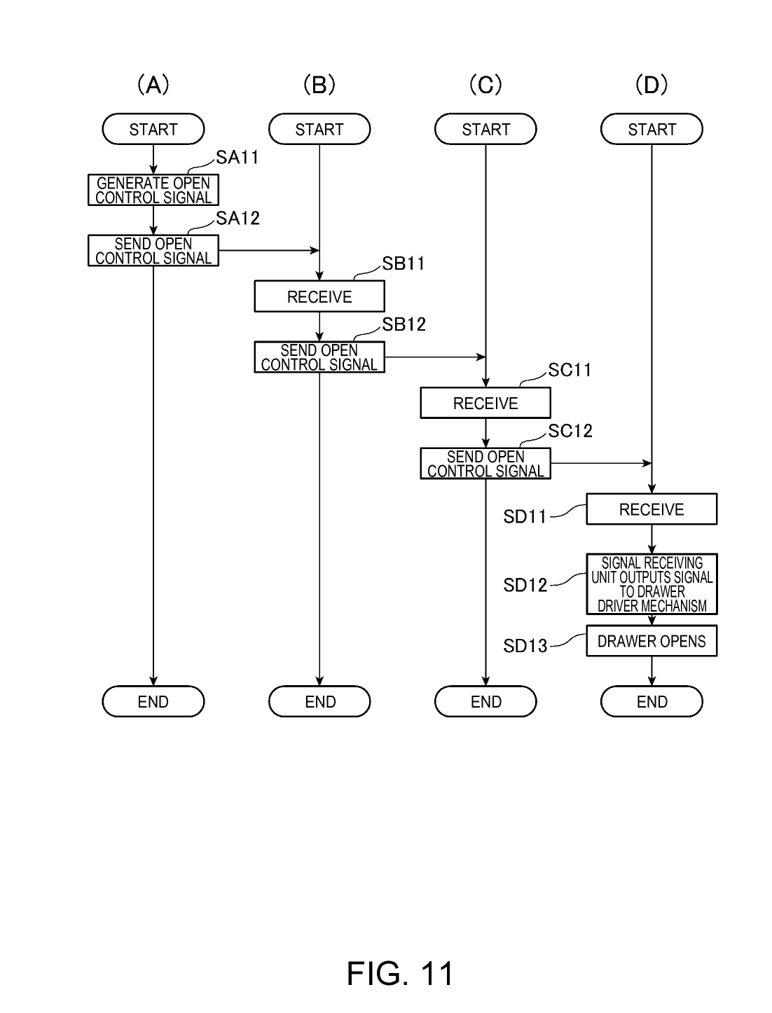

FIG. 11 is a flow chart of the operation devices in the control system 1a to process a transaction. Column (A) of FIG. 11 shows the operation of the tablet terminal 10a, (B) shows the operation of the mobile printer 11a, (C) shows the operation of the cradle 13a, and (D) shows the operation of the cash drawer 14a.

To run a transaction, the waiter goes to the checkout counter LCa and places the assigned mobile printer 11a in the cradle 13a as described above. The steps in column (B) of FIG. 11 show the operation of the mobile printer 11a when installed to the cradle 13a.

When the mobile printer 11a is placed in the cradle 13a, the mobile printer 11a and the cradle 13a execute the following process.

Specifically the cradle 13a authenticates the installed mobile printer 11a. More specifically, the control unit 40a of the cradle 13a monitors if a mobile printer 11a is installed through the USB connection. As described above, the mobile printer 11a and cradle 13a can communicate through USB by installing the mobile printer 11a to the cradle 13a.

When installation of a mobile printer 11a is detected, the control unit 40a of the cradle 13a requests the mobile printer 11a to return its ID and password for authentication. The device control unit 30a of the mobile printer 11a then sends the device ID and password to the cradle 13a. The device ID and password are previously set, and are stored in a specific storage area of the mobile printer 11a.

The control unit 40a of the cradle 13a thus receives the ID and password sent by the mobile printer 11a. The IDs and passwords of approved mobile printers 11a are stored in sets in a list in a specific storage area of the cradle 13a. The control unit 40a references the sets of IDs and passwords stored in the specific storage area, and determines if the ID and password received from the mobile printer 11a match those of an approved mobile printer 11a.

If the received ID and pas sword belong to an approved mobile printer 11a, the control unit 40a determines that authentication was successful. If authentication is successful, the control unit 40a accepts data from the mobile printer 11a, and when data is received from the mobile printer 11a, executes a process based on the received data.

If the received ID and password do not belong to an approved mobile printer 11a, the control unit 40a determines that authentication failed. If authentication fails, the control unit 40a runs an appropriate handling process and does not accept data from the mobile printer 11a. The handling process may include the control unit 40a driving the LED unit 44a to turn one or more LEDs on and off in a specific way signaling an authentication failure.

By executing the foregoing process when a mobile printer 11a is installed to the cradle 13a, the cradle 13a is prevented from executing any process under the control of a mobile printer 11a that is not authorized. As a result, as will become clear below, the cash drawer 14a opening in response to control by an unauthorized mobile printer 11a is prevented.

Note that when the operation shown in column (C) of FIG. 11 starts, the mobile printer 11a installed to the cradle 13a has already been successfully authenticated.

The terminal control unit 20a of the tablet terminal 10a provides a user interface for inputting transaction information. The waiter inputs transaction data through the user interface, and inputs when the transaction total is determined for a customer. Because money is exchanged in some form with the customer when the transaction total is determined, the cash drawer 14a must be opened.

As shown in column (A) of FIG. 11, when a command finalizing the transaction total is input through the user interface, the terminal control unit 20a of the tablet terminal 10a generates control data (open control signal) instructing the cash drawer 14a to open (step SA11).

Next, the terminal control unit 20a controls the terminal wireless communication unit 22a to send the open control signal generated in step SA11 to the mobile printer 11a (step SA12).

As shown in column (B) of FIG. 11, the device control unit 30a of the mobile printer 11a then controls the device wireless communication unit 32a to receive the open control signal (step SB11).

Next, the device control unit 30a controls the device communication interface 33a to send the open control signal to the cradle 13a (step SB12).

To send the open control signal, the device control unit 30a may process the open control signal in a specific way, such as for compatibility with the command language of the cradle 13a.

As shown in column (C) of FIG. 11, the control unit 40a of the cradle 13a controls the communication interface 41a to receive the open control signal (step SC11).

Next, the control unit 40a controls the signal transmission unit 43a to send the Open signal to the cash drawer 14a (step SC12).

As described above, the cradle 13a and the cash drawer 14a are connected by wire through the signal cable 15a. The signal transmission unit 43a therefore sends the Open signal through the signal cable 15a to the cash drawer 14a.

As shown in column (D) of FIG. 11, the signal receiving unit 50a of the cash drawer 14a receives the Open signal sent by the cradle 13a (step SD11).

Next, the signal receiving unit 50a generates and outputs to the drawer driver mechanism 51a a signal for opening the drawer (step SD12).

When the signal is received, the drawer driver mechanism 51a disengages the lock mechanism and controls the kicker mechanism to move the drawer unit 142a in the specific direction and the cash drawer 14a to open (step SD13).

The cradle 13a and cash drawer 14a are thus connected directly by wire in this embodiment of the invention. Opening the cash drawer 14a is controlled by the mobile printer 11a installed to the cradle 13a, and the cradle 13a outputting an Open signal through a signal cable 15a to the cash drawer 14a.

As a result, the cash drawer 14a can be securely opened without connecting the mobile printer 11a and cash drawer 14a by wire.

The basic operation of the tablet terminal 10a and mobile printer 11a when producing a receipt is described next.

The terminal control unit 20a of the tablet terminal 10a run a payment process according to the customer transaction, and generate control data based on the payment process.

More specifically, the terminal control unit 20a generates receipt information containing information to record on the receipt according to the customer's transaction. The receipt information is information including, for example, information related to a logo printed on the receipt; when the receipt is printed (date and time); information related to the names, prices, quantities, and applicable tax for the products the customer purchased; the purchase total; the amount received from the customer; the amount of change due; or other information. When processing a customer transaction in the business, the terminal control unit 20a gets required information from product master and customer master databases, for example, by specific means as needed and generates the receipt information based on input by the waiter.

After generating the receipt information, the terminal control unit 20a generates control data, which is control data based on the command language of the mobile printer 11a, instructing printing the receipt information.

Next, the terminal control unit 20a controls the terminal wireless communication unit 22a to send the generated control data to the mobile printer 11a.

The device control unit 30a of the mobile printer 11a controls the device wireless communication unit 32a to receive the control data.

Next, the device control unit 30a controls the recording unit 31a based on the control data to record the receipt information on roll paper, cut the paper at a specific position, and thereby produce a receipt.

As described above, a control system 1a according to this embodiment has a cradle 13a that charges a mobile printer 11a (recording device) installed thereto, and a cash drawer 14a connected by wire to the cradle 13a. The cradle 13a communicates with the installed mobile printer 11a, and outputs a signal to open the cash drawer 14a as controlled by the installed mobile printer 11a.

Thus comprised, the cash drawer 14a can be opened securely without connecting the mobile printer 11a and the cash drawer 14a by wire.

The control system 1a according to this embodiment also has a tablet terminal 10a (control device) that communicates with the mobile printer 11a. The mobile printer 11a controls the cradle 13a to output a control signal to the cash drawer 14a as controlled by the tablet terminal 10a.

Thus comprised, the cash drawer 14a can be opened securely as controlled by the tablet terminal 10a.

In this embodiment of the invention, the tablet terminal 10a sends control data instructing producing a receipt for a transaction to the mobile printer 11a, and the mobile printer 11a issues a receipt based on the received control data.

Thus comprised, the cash drawer 14a can be opened securely in a system that produces receipts for transactions.

Furthermore, when a mobile printer 11a is installed, the cradle 13a according to this embodiment authenticates the installed mobile printer 11a and outputs a signal to the cash drawer 14a as controlled by the mobile printer 11a when authentication is successful. Thus comprised, the cash drawer 14a being opened by an unauthorized mobile printer 11a can be prevented.

The invention is described above with reference to a preferred embodiment thereof, but the invention is not limited thereto and can be modified and adapted in many ways without departing from the scope of the accompanying claims.

For example, the mobile printer 11a in the foregoing embodiment uses a thermal recording method, but the recording method is not limited to thermal printing. More specifically, the invention can be used with any recording device that can be charged by the cradle 13a irrespective of the recording method used.

The function units described above can also be achieved as desired using hardware and software, and do not suggest a specific hardware configuration.

Furthermore, the mobile printer 11a and cradle 13a communicate by USB in the foregoing embodiment. Any desirable standard can be used for communication between devices, however, including Bluetooth or other near-field communication technology, and other wired communication standards.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A cradle that charges an installed recording device, comprising:
a control unit that communicates with the installed recording device and executes a specific process.

2. The cradle described in claim 1, further comprising:
a first communication unit that communicates with an external device; and
a second communication unit that communicates with the recording device;
wherein the control unit configures the recording device through the second communication unit based on communication with the external device through the first communication unit.

3. The cradle described in claim 2, wherein:
the control unit updates firmware of the recording device through the second communication unit based on communication with the external device through the first communication unit.

4. The cradle described in claim 2, wherein:
the control unit detects if the recording device is installed, and if installation of the recording device is detected, acquires a status related to configuration of the recording device through the second communication unit, and executes a process appropriate to the status related to configuration of the recording device acquired through the second communication unit.

5. The cradle described in claim 1, wherein:
the cradle is connected by wire to a cash drawer; and
the control unit communicates with the installed recording device, and outputs a signal to open the cash drawer based on control of the installed recording device.

6. The cradle described in claim 1, wherein:
the control unit authenticates the installed recording device when a recording device is installed, and if authentication is successful, outputs a signal to the cash drawer based on control of the recording device.

7. A control method of a cradle that charges an installed recording device, comprising:
communicating with the installed recording device and executing a specific process.

8. The control method of a cradle described in claim 7, further comprising:
communicating with an external device; and
configuring the recording device based on communication with the external device.

9. The control method of a cradle described in claim 7, further comprising:
communicating with an installed recording device; and outputting a signal to a cash drawer connected by wire to open the cash drawer based on control of the installed recording device.

10. A control system comprising:
a cradle that charges an installed recording device; and
a cash drawer connected by wire to the cradle;
wherein the cradle communicates with the installed recording device, and outputs a signal to open the cash drawer based on control of the installed recording device.

11. The control system described in claim 10, further comprising:
a control device that communicates with the recording device;
the recording device controlling the cradle and outputting a signal to the cash drawer based on control of the control device.

12. The control system described in claim 11, wherein:
the control device sends control data instructing recording on a recording medium to the recording device; and
the recording device records on the recording medium based on the received control data.

13. The control system described in claim 10, wherein:
the cradle authenticates the installed recording device when a recording device is installed, and if authentication is successful, outputs a signal to the cash drawer based on control of the recording device.
